(19) United States
(12) Patent Application Publication
(10) Pub. No.: US 2025/0146437 A1
(43) Pub. Date: May 8, 2025

(54) Processes and Systems for Recovering Heat and Generating Power

(71) Applicant: MODEC International, Inc., Houston, TX (US)

(72) Inventors: Randy W. Jenkins, Deer Park, TX (US); Srinivas R. Arcot, Fulshear, TX (US)

(73) Assignee: MODEC International, Inc., Houston, TX (US)

(21) Appl. No.: 18/934,265

(22) Filed: Nov. 1, 2024

Related U.S. Application Data
(60) Provisional application No. 63/596,065, filed on Nov. 3, 2023.

(51) Int. Cl. F02C 6/18; F28D 7/00

(52) U.S. Cl. CPC F02C 6/18; F28D 7/00; F05D 2220/72; F05D 2260/213

(57) ABSTRACT

Processes and systems for recovering heat and generating power. In some embodiments, the process can include combusting a fuel to produce a heated exhaust gas. Heat can be indirectly transferred from the heated exhaust gas to a pre-heated first aqueous fluid to produce a steam feed and a first cooled exhaust gas. At least a portion of the steam feed can be introduced into a steam turbine generator to produce power and a cooled first aqueous fluid. Heat can be indirectly transferred from the first cooled exhaust gas to a cooled second aqueous fluid to produce a heated second aqueous fluid and a second cooled exhaust gas. Heat can be indirectly transferred from the heated second aqueous fluid to the cooled first aqueous fluid to produce the pre-heated first aqueous fluid and an intermediately cooled second aqueous fluid.

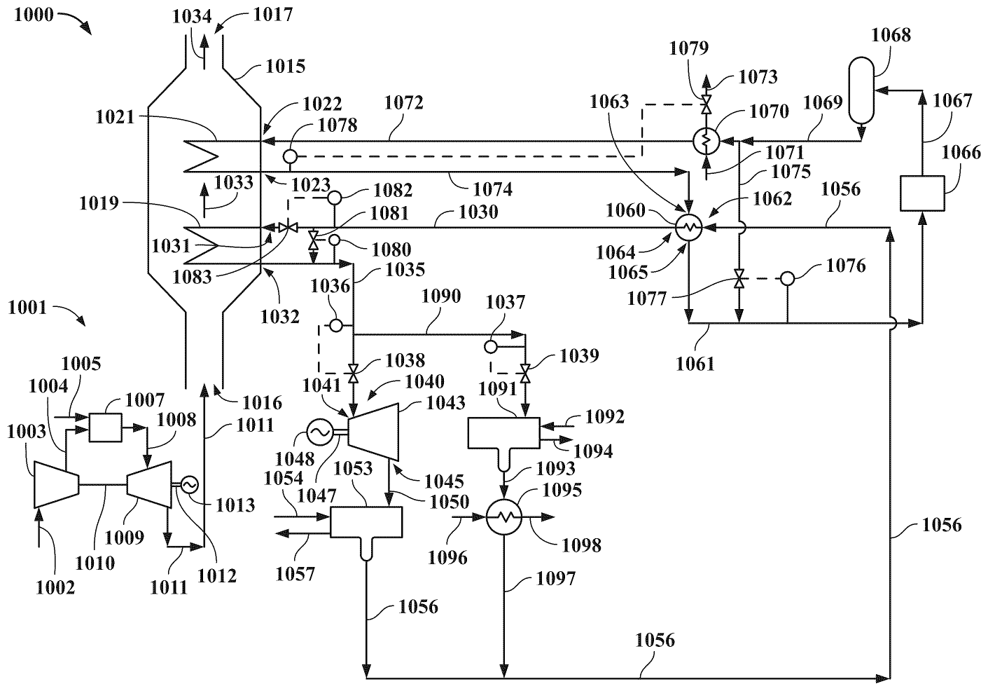

### CROSS-REFERENCE TO RELATED APPLICATION

This application claims priority to U.S. Provisional Patent Application No. 63/596,065, filed on Nov. 3, 2023, which is incorporated by reference herein.

### FIELD

Embodiments described generally relate to processes and systems for recovering heat and generating power. More particularly, such embodiments relate to combined cycle heat and power generation systems and processes that utilize two separate coils for heat recovery that can be utilized in power generation and process/utility heating, respectively.

### BACKGROUND

Floating Production, Storage, and Offloading (FPSO) vessels, as well as other vessels and offshore installations, have been equipped with power generation systems to provide power and heat energy to the vessel and operations thereon. One system is the gas turbine power plant that uses a gas turbine to combust a fuel to produce a heated exhaust gas that drives a load, e.g., an electrical generator. A given gas turbine system can include one or more gas turbines depending on the power requirements for the given system. A large amount of heat in the heated exhaust gas is typically lost to the atmosphere. To recover some of the heat produced from gas turbines, combined cycle heat and power plants were developed that integrate a steam turbine generator. Such combined cycle power plants combine a gas turbine with a heat recover steam generator and a steam turbine to produce additional power while reducing energy waste in the form of heated exhaust. More particularly, combined cycle power plants use the thermal energy in the heated exhaust produced in the gas turbine to produce steam and the steam is introduced into the steam turbine that drives a load, e.g., another electrical generator. Heat energy for process/utility heating can be obtained from steam as the heat source with steam turbine extraction at a desired pressure and temperature and steam heat energy backup from heat recovery steam generator that can include a steam let down station in the even the steam turbine is shut down.

Conventional combined cycle power plants include a large amount of equipment with backup equipment and a significant amount of high pressure piping and other equipment in the steam turbine generator cycle, such as pressure let down stations, extraction control, and oversized condenser of the combined cycle power plant due to interdependency and integration of combined heat and power systems. The high pressure high temperature steam that circulates throughout the steam turbine generator cycle results in the combined cycle power plant having thicker walls for piping and equipment resulting in heavier systems and a relatively large footprint for integration and backup systems. Conventional combined cycle heat and power plants also require high purity water to be used throughout the steam systems which further increases the equipment required to process the water in the steam turbine generator cycle.

There is a need, therefore, for improved combined cycle heat and power plants that require less equipment, reduce interdependency, improve heat recovery, and/or reduce weight in the heating steam and steam turbine generator cycle of combined cycle heat and power plants, particularly when the combined cycle power plant is located on a vessel or other location that has limited space. This disclosure satisfies this and other needs.

### SUMMARY

Processes and systems for recovering heat and generating power are provided. In some embodiments, the system can include a combustor, a housing, a first coil, a steam turbine generator, a second coil, and a primary indirect heat exchanger. The combustor can be configured to combust a fuel to produce a heated exhaust gas. The housing can have an inlet configured to receive the heated exhaust gas and an outlet configured to remove a cooled exhaust gas therefrom. The first coil can be disposed within the housing and can have an inlet configured to receive a pre-heated first aqueous fluid and an outlet configured to remove a steam feed therefrom. The steam turbine generator can have an inlet configured to receive at least a portion of the steam feed from the outlet of the first coil to produce power and an outlet configured to remove a cooled first aqueous fluid therefrom. The second coil can be disposed within the housing and can have an inlet configured to receive a cooled second aqueous fluid and an outlet configured to remove a heated second aqueous fluid therefrom. The primary indirect heat exchanger can have a first inlet, a second inlet, a first outlet, and a second outlet. The first inlet of the primary indirect heat exchanger can be configured to receive the cooled first aqueous fluid from the steam turbine generator. The second inlet of the indirect heat exchanger can be configured to receive the heated second aqueous fluid from the second coil. The primary indirect heat exchanger can be configured to indirectly transfer heat from the heated second aqueous fluid to the cooled first aqueous fluid to produce the pre-heated first aqueous fluid and an intermediately cooled second aqueous fluid. The first outlet of the primary indirect heat exchanger can be in fluid communication with the inlet of the first coil. The second outlet of the primary indirect heat exchanger can be in fluid communication with the inlet of the second coil.

In some embodiments, the process can include combusting a fuel to produce a heated exhaust gas. Heat can be indirectly transferred from the heated exhaust gas to a pre-heated first aqueous fluid to produce a steam feed and a first cooled exhaust gas. At least a portion of the steam feed can be introduced into a steam turbine generator to produce power and a cooled first aqueous fluid. Heat can be indirectly transferred from the first cooled exhaust gas to a cooled second aqueous fluid to produce a heated second aqueous fluid and a second cooled exhaust gas. Heat can be indirectly transferred from the heated second aqueous fluid to the cooled first aqueous fluid to produce the pre-heated first aqueous fluid and an intermediately cooled second aqueous fluid.

In other embodiments, the process can include combusting a fuel within a combustor to produce a heated exhaust gas. At least a portion of the heated exhaust gas can be introduced into an inlet of a housing that can include a first coil and a second coil disposed therein. A pre-heated first aqueous fluid can be introduced into an inlet of the first coil. Heat can be indirectly transferred from the heated exhaust gas to the pre-heated first aqueous fluid flowing through the first coil to produce a steam feed and a first cooled exhaust gas. The steam feed can be removed from the first coil via an outlet of the first coil. At least a portion of the steam feed can be introduced into an inlet of a steam turbine generator to produce power and a cooled first aqueous fluid. The cooled first aqueous fluid can be removed from the steam turbine generator via an outlet of the steam turbine generator. A cooled second aqueous fluid can be introduced into an inlet of the second coil. Heat can be indirectly transferred from the first cooled exhaust gas to the cooled second aqueous fluid flowing through the second coil to produce a heated second aqueous fluid and a second cooled exhaust gas. The heated second aqueous fluid can be removed from the second coil via an outlet of the second coil. The second cooled exhaust gas can be removed from the housing through an outlet of the housing. The cooled first aqueous fluid can be introduced into a first inlet of an indirect heat exchanger. The heated second aqueous fluid can be introduced into a second inlet of the indirect heat exchanger. Heat can be indirectly exchanged from the heated second aqueous fluid to the cooled first aqueous fluid to produce the pre-heated first aqueous fluid and an intermediately cooled second aqueous fluid. The pre-heated first aqueous fluid can be removed from the indirect heat exchanger via a first outlet of the indirect heat exchanger. The first outlet of the indirect heat exchanger can be in fluid communication with the inlet of the steam turbine generator. The intermediately cooled second aqueous fluid can be removed from the indirect heat exchanger via a second outlet of the indirect heat exchanger. The inlet of the second coil can be in fluid communication with the second outlet of the indirect heat exchanger.

### BRIEF DESCRIPTION OF THE DRAWINGS

The various aspects and advantages of the preferred embodiment of the present invention will become apparent to those skilled in the art upon an understanding of the following detailed description of the invention, read in light of the accompanying drawings which are made a part of this specification.

The FIGURE depicts a schematic of an illustrative system for recovering heat and generating power therefrom, according to one or more embodiments described.

### DETAILED DESCRIPTION

A detailed description will now be provided. Each of the appended claims defines a separate invention, which for infringement purposes is recognized as including equivalents to the various elements or limitations specified in the claims. Depending on the context, all references to the “invention”, in some cases, refer to certain specific or preferred embodiments only. In other cases, references to the “invention” refer to subject matter recited in one or more, but not necessarily all, of the claims. It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the figures provided herein. This repetition is for the purpose of simplicity and clarity and does not in itself dictate a relationship between the various exemplary embodiments and/or configurations discussed in the Figures. Moreover, the formation of a first feature over or on a second feature in the description that follows includes embodiments in which the first and second features are formed in direct contact and also includes embodiments in which additional features are formed interposing the first and second features, such that the first and second features are not in direct contact. The exemplary embodiments presented below may be combined in any combination of ways, i.e., any clement from one exemplary embodiment may be used in any other exemplary embodiment, without departing from the scope of the disclosure. The figures are not necessarily drawn to scale and certain features and certain views of the figures can be shown exaggerated in scale or in schematic for clarity and/or conciseness.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Also, the naming convention used herein is not intended to distinguish between components that differ in name but not function. Furthermore, in the following discussion and in the claims, the terms “including” and “comprising” are used in an open-ended fashion, and thus should be interpreted to mean “including, but not limited to.”

All numerical values in this disclosure are exact or approximate values (“about”) unless otherwise specifically stated. Accordingly, various embodiments of the disclosure may deviate from the numbers, values, and ranges disclosed herein without departing from the intended scope.

Further, the term “or” is intended to encompass both exclusive and inclusive cases, i.e., “A or B” is intended to be synonymous with “at least one of A and B,” unless otherwise expressly specified herein. The indefinite articles “a” and “an” refer to both singular forms (i.e., “one”) and plural referents (i.e., one or more) unless the context clearly dictates otherwise. The terms “up” and “down”; “upward” and “downward”; “upper” and “lower”; “upwardly” and “downwardly”; “above” and “below”; and other like terms used herein refer to relative positions to one another and are not intended to denote a particular spatial orientation since the apparatus and processes for using the same may be equally effective at various angles or orientations.

In some embodiments, a process for generating power can include combusting a fuel to produce a heated exhaust gas. The fuel can be combusted in the presence of any suitable oxidant or combination of oxidants. In some embodiments, the fuel can be or can include, but is not limited to, molecular hydrogen, one or more hydrocarbons, one or more high temperature fluids that can be gaseous and/or liquid at atmospheric pressure and ambient temperature, or any combination thereof. In other embodiments, the fuel can be or can include, but is not limited to one or more fluidized combustible particles, e.g., coal particles fluidized with a gas such as carbon dioxide. In some embodiments, the fuel can be obtained by heating crude oil or produced crude located within a storage tank that can cause lighter hydrocarbons, e.g., C₅₋ hydrocarbons, produced natural gas, and/or associated gas, to vaporize that can then be utilized as the fuel. In other embodiments, the fuel can be or can include one or more hydrocarbons that can be liquid at atmospheric temperature and pressure, e.g., gasoline or diesel. In some embodiments, the fuel can be a hydrocarbon that has a relatively low sulfur content, e.g., ≤1.5 wt % or ≤1 wt % of sulfur. In some embodiments, the oxidant can be or can include, but is not limited to, air, oxygen enriched air, oxygen depleted air, or any mixture thereof.

The fuel can be combusted in the presence of the oxidant in any suitable combustion vessel or chamber. In some embodiments, the fuel can be combusted in a combustion chamber of a gas turbine, in a combustion chamber of an incinerator, a supplemental firing burner, or any combination thereof. In at least one embodiment, the exhaust gas can be produced by combusting the fuel in the presence of the oxidant, e.g., air, in a combustor of a gas turbine. In such embodiment, the fuel and a compressed oxidant obtained from a compressor of the gas turbine can be introduced into the combustor and the combustion product can be introduced into the turbine of the gas turbine to produce power with the heated exhaust gas recovered from an outlet of the gas turbine.

Heat can be indirectly transferred from the heated exhaust gas to a pre-heated first aqueous fluid to produce a steam feed and a first cooled exhaust gas. In some embodiments, the heated exhaust gas can be introduced into an inlet of a housing that can include a first coil and a second coil disposed therein. In some embodiments, the first coil can be disposed within the housing toward the inlet of the housing and the second coil can be disposed within the housing between the first coil and an outlet of the housing. In some embodiments, the pre-heated first aqueous fluid can be introduced into an inlet of the first coil. The pre-heated first aqueous fluid can flow through the first coil and can be heated therein to produce the steam feed, which can be removed after heat exchange from the first coil via an outlet of the first coil. Heat from the heated exhaust gas can be indirectly transferred through the wall of the first coil to the pre-heated first aqueous fluid to produce the steam feed and the first cooled exhaust gas.

In some embodiments, the heated exhaust gas can be at a temperature in a range from about 350° C., about 400° C., about 425° C., about 450° C., about 475° C., about 500° C., about 525° C., or about 535° C. to about 550° C., about 575° C., about 600° C., or about 625° C. when introduced into the inlet of the housing and initially contacted with the first coil. In some embodiments, the pre-heated first aqueous fluid can be at a temperature in a range from about 75° C., about 80° C., or about 85° C. to about 90° C., about 95° C., or about 99° C. when introduced into the inlet of the first coil. In some embodiments, the pre-heated first aqueous fluid can be in a liquid phase. In other embodiments, a first portion or quantity of the pre-heated first aqueous fluid can be in a liquid phase and a second portion or quantity of the pre-heated first aqueous fluid can be in a gaseous phase when initially introduced into the inlet of the first coil. In some embodiments, the first cooled exhaust gas can be at a temperature in a range from about 150° C., about 200° C., about 250° C., about 255° C., about 275° C., or about 300° C. to about 330° C., about 345° C., about 350° C., or about 375° C. In some embodiments, the steam feed can be at a temperature in a range from about 400° C., about 410° C., about 420° C., or about 425° C. to about 435° C., about 445° C., about 450° C., or about 460° C. upon exiting the outlet of the first coil. In some embodiments, the steam feed can be at a pressure in a range from about 4,000 kPa-gauge, about 4,250 kPa-gauge, or about 4,500 kPa-gauge to about 4,750 kPa-gauge, about 5,000 kPa-gauge, about 5,250 kPa-gauge, or about 5,500 kPa-gauge upon exiting the outlet of the first coil.

Remaining heat can be indirectly transferred from the first cooled exhaust gas to a cooled second aqueous fluid to produce a heated second aqueous fluid and a second cooled exhaust gas. In some embodiments, the cooled second aqueous fluid can be introduced into an inlet of the second coil. The second cooled aqueous fluid can flow through the second coil and be heated therein to produce the heated second aqueous fluid, which can be removed after heat exchange from the second coil via an outlet of the second coil. Heat from the first cooled exhaust gas can be indirectly transferred through the wall of the second coil to the cooled second aqueous fluid to produce the heated second aqueous fluid and the second cooled exhaust gas. The second cooled exhaust gas can exit the housing via the outlet of the housing.

In some embodiments, the first cooled exhaust gas with remaining heat can be at a temperature in a range from about 150° C., about 200° C., about 250° C., about 255° C., about 275° C., or about 300° C. to about 330° C., about 345° C., about 350° C., or about 375° C. when initially contacted with the second coil. In some embodiments, the cooled second aqueous fluid can be at a temperature in a range from about 50° C., about 55° C., about 60° C., about 65° C., or about 70° C. to about 80° C., about 85° C., about 90° C., about 95° C., or about 99° C. when introduced into the inlet of the second coil. In some embodiments, the cooled second aqueous fluid can be at a pressure in a range from about 700 kPa-gauge, about 800 kPa-gauge, or about 900 kPa-gauge to about 1,000 kPa-gauge, about 1,100 kPa-gauge, about 1,200 kPa-gauge, or about 1,300 kPa-gauge when introduced into the inlet of the second coil. In some embodiments, the cooled second aqueous fluid can be in a liquid phase. In other embodiments, a first portion or quantity of the cooled second aqueous fluid can be in a liquid phase and a second portion or quantity of the cooled second aqueous fluid can be in a gaseous phase when initially introduced into the inlet of the second coil.

In some embodiments, the second cooled exhaust gas can be at a temperature in a range from about 130° C., about 150° C., or about 170° C. to about 180° C., about 190° C., or about 200° C. upon exiting the outlet of the housing. In some embodiments, the heated second aqueous fluid can be at a temperature in a range from about 140° C., about 150° C., about 160° C., or about 170° C. to about 180° C., about 190° C., about 200° C., or about 210° C. upon exiting the outlet of the second coil. In some embodiments, the heated second aqueous fluid can be at a pressure in a range from about 700 kPa-gauge, about 800 kPa-gauge, or about 900 kPa-gauge to about 1,000 kPa-gauge, about 1,100 kPa-gauge, about 1,200 kPa-gauge, or about 1,300 kPa-gauge upon exiting the outlet of the second coil. In some embodiments, the heated second aqueous fluid can be in a liquid phase. In other embodiments, a first portion or quantity of the heated second aqueous fluid can be in a liquid phase and a second portion or quantity of the heated second aqueous fluid can be in a gaseous phase upon exiting the outlet of the second coil.

At least a portion of the steam feed can be introduced into a steam turbine generator. The steam turbine generator can be any suitable steam turbine generator. In some embodiments, the steam feed can be produced via a once through steam generator (OTSG), a heat recovery steam generator (HRSG), or a combination thereof. The at least a portion of the steam feed can be introduced into an inlet of the steam turbine generator to produce power and a cooled first aqueous fluid. The cooled first aqueous fluid can be removed from the steam turbine generator via an outlet of the steam turbine generator.

In some embodiments, the cooled first aqueous fluid can be at a pressure less than atmospheric pressure upon exiting the outlet of the steam turbine generator. In some embodiments, the cooled first aqueous fluid, which can also be referred to as a steam turbine exhaust steam, can be at a pressure in a range from about 3 kPa-absolute, about 10 kPa-absolute, or about 15 kPa-absolute to about 20 kPa-absolute, about 30 kPa-absolute, or about 40 kPa-absolute. In some embodiments, the cooled first aqueous fluid can be at a temperature in a range from about 15° C., about 17° C., or about 20° C. to about 25° C., about 30° C., or about 40° C., about 50° C., about 60° C., or about 70° C. In some embodiments, the cooled first aqueous fluid can be at a temperature of about 70° C. or less. In some embodiments, the cooled first aqueous fluid can be at least partially condensed upon exiting the outlet of the steam turbine generator. In some embodiments, the cooled first aqueous fluid, upon exiting the outlet of the steam turbine generator, can contain liquid water in an amount of about 75 wt %, about 80 wt %, or about 85 wt % to about 90 wt %, about 95 wt %, or about 98 wt %, based on the total weight of the cooled first aqueous fluid. In other embodiments, the cooled first aqueous fluid, upon exiting the outlet of the steam turbine generator can be essentially liquid water, e.g., at least 99 wt % of liquid water based on the total weight of the cooled first aqueous fluid.

In some embodiments, the cooled first aqueous fluid can be introduced into a first inlet of a primary indirect heat exchanger and the heated second aqueous fluid can be introduced into a second inlet of the primary indirect heat exchanger. Heat can be indirectly transferred from the heated second aqueous fluid to the cooled first aqueous fluid within the primary indirect heat exchanger to produce the pre-heated first aqueous fluid and an intermediately cooled second aqueous fluid. In some embodiments, the cooled first aqueous fluid can be at a temperature in a range from about 30° C., about 35° C., about 40° C., or about 45° C. to about 50° C., about 55° C., about 60° C., or about 65° C. In some embodiments, the cooled first aqueous fluid can be at a pressure in a range from about 3,500 kPa-gauge, about 4,000 kPa-gauge, or about 4,500 kPa-gauge to about 5,000 kPa-gauge, about 5,500 kPa-gauge, about 6,000 kPa-gauge, or about 6,500 kPa-gauge when introduced into the first inlet of the primary indirect heat exchanger. It should be understood that the pressure of the cooled first aqueous fluid (and other fluids) can be increased via one or more pumps or other pressure increasing devices. For example, a pump can be located between the outlet of the outlet of the steam turbine generator and the inlet of the primary indirect heat exchanger. In some embodiments, the heated second aqueous fluid can be at a pressure in a range from about 700 kPa-gauge, about 800 kPa-gauge, or about 900 kPa-gauge to about 1,000 kPa-gauge, about 1,100 kPa-gauge, about 1,200 kPa-gauge, or about 1,300 kPa-gauge when introduced into the second inlet of the primary indirect heat exchanger. As such, should a leak occur within the primary indirect heat exchanger, the cooled first aqueous fluid of higher quality/purity can flow into and mix with the heated second aqueous fluid rather than the heated second aqueous fluid of lower quality/purity flowing into and mixing with the cooled first aqueous fluid. The pre-heated first aqueous fluid can be reintroduced into the inlet of the first coil to produce additional steam feed. The intermediately cooled second aqueous fluid can be at a temperature in a range from about 105° C., about 110° C., or about 115° C. to about 120° C., about 125° C., about 130° C., or about 135° C.

In some embodiments, at least a portion of the cooled first aqueous fluid upon exiting the outlet of the steam turbine generator can pass through a primary condenser prior to indirectly transferring heat from the heated second aqueous fluid to the cooled first aqueous fluid. In such embodiment, the primary condenser can be configured to indirectly transfer heat from the cooled first aqueous fluid to a cooling medium such that a temperature of the cooled first aqueous fluid can be further reduced as compared to the temperature of the first aqueous fluid upon exiting the outlet of the steam turbine generator. In some embodiments, the cooling medium introduced into the primary condenser can be or can include, but is not limited to, water. In some embodiments, the cooling medium can be or can include water obtained from a body of water such water from an ocean, sea, gulf, or any other body of water.

In some embodiments, a first portion of the steam feed obtained from the outlet of the first coil can be introduced into the steam turbine generator such that the cooled first aqueous fluid recovered from the outlet of the steam turbine generator includes a first portion of the first steam feed. In such embodiment, a second portion of the steam feed obtained from the outlet of the first coil can be introduced into an inlet of an auxiliary condenser. The auxiliary condenser can transfer heat from the second portion of the steam feed to a cooling medium to produce a cooled second portion of the first steam feed. In some embodiments, the auxiliary condenser can include one or more heat exchangers that can cool the second portion of the steam feed to a suitable temperature.

In some embodiments, the auxiliary condenser can include one or more main heat exchangers and one or more sub-coolers. In such embodiment, the second portion of the steam feed can be cooled within the main heat exchanger to produce an intermediately cooled second portion of the steam feed and the sub-cooler can receive and further cool the intermediately cooled second portion of the steam feed to produce a cooled second portion of the steam feed. The sub-cooler can be used to ensure the cooled second portion of the steam feed can be in the liquid phase. In some embodiments, the cooling medium or heat transfer medium introduced into the auxiliary condenser, e.g., the main heat exchanger and the sub-cooler, can be or can include, but is not limited to, water. In some embodiments, the cooling medium can be or can include water obtained from a body of water such water from an ocean, sea, gulf, or any other body of water. In some embodiments, the cooling medium can be obtained from a depth of the body of water such that the cooling medium is at a temperature that is lower than the temperature of the surface of the body of water, e.g., at a temperature in a range of about 20° C. to about 25° C., about 10° C. to 15° C., about 5° C. to 10° C., or even less than 5° C. The cooled second portion of the steam feed obtained from the auxiliary condenser can be at a temperature in a range from about 15° C., about 17° C., or about 20° C. to about 25° C., about 30° C., or about 40° C., about 50° C., or about 60° C.

When the steam turbine generator receives the first portion of the steam feed and the auxiliary condenser receives the second portion of the steam feed, the cooled second portion of the steam feed obtained from the auxiliary condenser can be combined with the cooled first portion of the steam feed obtained from the primary condenser to produce the cooled first aqueous fluid.

It should be understood that one or more additional process units can be disposed between the primary condenser and, if present, the auxiliary condenser that can be configured to further process the cooled first aqueous fluid or the cooled first portion of the steam feed and the cooled second portion of the steam feed before introduction of the cooled first aqueous fluid into the first inlet of the indirect heat exchanger. In some embodiments, such additional process units can be or can include, but are not limited to, one or more vacuum units, one or more vacuum deaerators, a polishing unit, a filter unit, e.g., an activated carbon filter, one or more demineralization units, one or more mixed bed polishers, one or more electro-deionization (EDI) modules, one or more reverse osmosis units, or any combination thereof. It should also be understood that a portion of the cooled first aqueous fluid can be recycled, e.g., to the inlet of the primary condenser and/or to a flash vessel from which the aqueous fluid can be recycled to mix with the cooled first aqueous fluid upon exiting the primary condenser, and so on. The additional process units and configurations or arrangements thereof that can be used to further treat or process the first cooled aqueous fluid recovered from the primary condenser and, if present, the auxiliary condenser are well-known to persons having ordinary skill in the art.

It should also be understood that one or more pumps or other fluid circulating devices can be used to move the cooled first aqueous fluid or the cooled first portion of the steam feed and the cooled second portion of the steam feed. It should also be understood that one or more pumps or other fluid circulating devices can be used to move the second aqueous fluid through the closed loop. For example, in some embodiments, one or more pumps can be located between the primary indirect heat exchanger and the trim cooler that can be used to circulate the second aqueous medium.

In some embodiments, heat can be indirectly transferred from the intermediately cooled second aqueous fluid to one or more heat transfer mediums to produce the cooled second aqueous fluid. In some embodiments, the one or more heat transfer mediums that can indirectly receive heat from the intermediately cooled second aqueous fluid can be or can include, but are not limited to, one or more additional aqueous fluids, one or more liquid hydrocarbons, one or more gaseous hydrocarbons, fuel gas utility heater, or any combination thereof. In some embodiments, the heat medium can be utilized as a source of heat within an oil heater, within a fuel gas heater, or a combination thereof. In some embodiments, the cooled second aqueous fluid can pass through an expansion drum or vessel prior to reintroducing the cooled second aqueous fluid into the inlet of the second coil.

In other embodiments, the intermediately cooled second aqueous fluid can be a first intermediately cooled second aqueous fluid and heat can be indirectly transferred from the first intermediately cooled second aqueous fluid to one or more first heat transfer mediums to produce a second intermediately cooled second aqueous fluid. For example, in some embodiments, heat can be indirectly transferred from the first intermediately cooled second aqueous fluid to a heat user or heat sink within a first secondary indirect heat exchanger to produce the second intermediately cooled second aqueous fluid. In some embodiments, the second intermediately cooled second aqueous fluid can pass through an expansion vessel. In some embodiments, the second intermediately cooled second aqueous fluid, e.g., after passing through the expansion vessel, can be further cooled within a trim cooler (which can also be referred to as a second secondary indirect heat exchanger) by indirectly transferring heat from the second intermediately cooled second aqueous fluid to one or more second heat transfer mediums to produce the cooled second aqueous fluid. In such embodiment, the second heat transfer medium can be or can include, but is not limited to, water. In some embodiments, the second heat transfer medium can be or can include water obtained from a body of water such water from an ocean, sea, gulf, or any other body of water. In some embodiments, the cooling medium can be obtained from a depth of the body of water such that the cooling medium is at a temperature that is lower than the temperature of the surface of the body of water, e.g., at a temperature of about 20° C. to about 25° C., or about 10° C. to about 15° C., or about 5° C. to about 10° C. or even less than about 5° C.

In some embodiments, a first portion of the second intermediately cooled second aqueous fluid can be combined with the first intermediately cooled second aqueous fluid upon the first intermediately cooled second aqueous fluid exiting the second outlet of the primary indirect heat exchanger. In such embodiment, heat can be indirectly transferred from a second portion of the second intermediately cooled second aqueous fluid to the one or more second heat transfer mediums within the trim cooler to produce the cooled second aqueous fluid.

In some embodiments, the first portion of the second intermediately cooled second aqueous fluid can be combined with the first intermediately cooled second aqueous fluid when the first intermediately cooled second aqueous fluid is at a temperature equal to or greater than a predetermined temperature to produce a combined feed having a temperature less than or equal to the predetermined temperature. In some embodiments, the second intermediately cooled second aqueous fluid can be at a temperature in a range from about 50° C., about 60° C., or about 70° C. to about 80° C., about 90° C., about 100° C., or about 105° C. In some embodiments, the predetermined temperature can be in a range of about 110° C., about 115° C., or about 120° C. to about 125° C., about 130° C., or about 135° C. As such, in some embodiments, the first portion of the second intermediately cooled second aqueous fluid can be combined with the intermediately cooled second aqueous fluid upon the intermediately cooled second portion exiting the second outlet of the primary indirect heat exchanger during some times of the process and not combined during other times of the process, depending on the temperature of the intermediately cooled second aqueous fluid exiting the second outlet of the primary indirect heat exchanger.

It should be noted that the second aqueous fluid, i.e., the cooled second aqueous fluid, the heated second aqueous fluid, and the intermediately or the first and second intermediately cooled second aqueous fluid can circulate within a closed loop. Similarly, the cooled first aqueous fluid, the pre-heated first aqueous fluid, and the steam feed can also circulate within a closed loop. In some embodiments, a purity of the first aqueous fluid can be greater than a purity of the second aqueous fluid. In other words, the composition of the first aqueous fluid can be different than the composition of the second aqueous fluid.

In some embodiments, the processes and systems for recovering heat and generating power disclosed herein can occur/be disposed on a vessel floating on a surface of a body of water. In such embodiments, the vessel can be any type of floating structure. In some embodiments, the vessel can be, but is not limited to, tankers; boats; ships; floating, storage, and offloading (FSO) vessels; FPSO vessels; and the like. In other embodiments, the processes and systems for recovering heat and generating power disclosed herein can occur on land. For example, in such embodiment, the processes and systems for recovering heat and generating power can occur within a refinery, an electric power generation facility, or any other suitable location.

The FIGURE depicts a schematic of an illustrative system 1000 for recovering heat and generating power therefrom, according to one or more embodiments. The system 1000 can include, but is not limited to, a gas turbine 1001, an exhaust duct or housing 1015 that can include a first coil 1019 and a second coil 1021 disposed therein, a steam turbine generator 1040, and a primary indirect heat exchanger 1060. In some embodiments, the first coil 1019 can be disposed within the housing 1015 toward an inlet 1016 of the housing 1015 and the second coil 1021 can be disposed within the housing 1015 between the first coil 1019 and an outlet 1017 of the housing 1015. In some embodiments, the system 1000 can also include a primary condenser 1053, an auxiliary condenser 1091, and a sub-cooler 1095. In some embodiments, the system 1000 can also include one or more heat medium users or heat medium sinks 1066 (which can also be referred to as a first secondary indirect heat exchanger), an expansion vessel 1068, and a trim cooler 1070.

The gas turbine 1001 can include a compressor 1003, a combustion chamber or combustor 1007, an expander 1009, and an electrical generator 1013. The compressor 1003 can receive an oxidant containing gas, e.g., air, via line 1002 and can produce a compressed oxidant via line 1004. The compressor 1003 can be any type of compressor. Illustrative compressors 1003 can include, but are not limited to, axial, centrifugal, rotary positive displacement, and the like. In some embodiments, the oxidant in line 1002 can be or can include, but is not limited to, air, oxygen enriched air, oxygen depleted air, or any mixture thereof.

The compressed oxidant via line 1004 and a fuel via line 1005 can be introduced into the combustor 1007. The fuel can be combusted within the combustor 1007 to produce a combustion product or heated exhaust gas via line 1008. In some embodiments, the fuel can be or can include, but is not limited to, molecular hydrogen, one or more hydrocarbons, one or more high temperature fluids that can be gaseous and/or liquid at atmospheric pressure and ambient temperature, or any combination thereof. In other embodiments, the fuel in line 1005 can be or can include, but is not limited to one or more fluidized combustible particles, e.g., coal particles fluidized with a gas such as carbon dioxide. In other embodiments, the fuel in line 1005 can be obtained by heating crude oil or produced crude located within a storage tank that can cause lighter hydrocarbons, e.g., C₅₋ hydrocarbons, produced natural gas, and/or associated gas, to vaporize that can then be utilized as the fuel. In still other embodiments, the fuel in line 1005 can be or can include one or more hydrocarbons that can be liquid at atmospheric temperature and pressure, e.g., gasoline or diesel.

The combustion product via line 1008 can be introduced into the expander 1009. The combustion product introduced into the expander 1009 can cause a turbine disposed therein to spin thereby generating mechanical power. In some embodiments, the mechanical power generated via the expander 1009 can be used to drive the electrical generator 1013 via shaft 1012. In other embodiments, a portion of the mechanical power generated via the expander 1009 can be used to power the electrical generator 1013 and a portion of the mechanical power generated via the expander 1009 can be used to drive the compressor via shaft 1010. The electrical generator 1009 can include any device capable of converting mechanical energy into electrical energy. Illustrative electrical generators 1009 can include, but are not limited to, synchronous and induction type generators.

An expanded heated exhaust gas or simply “heated exhaust gas” can be removed via line 1011 from the expander 1009. The heated exhaust gas via line 1011 can be introduced into the inlet 1016 of the housing 1015. The heated exhaust gas in line 1011 can be at a temperature in a range from about 350° C., about 425° C., about 450° C., or about 475° C. to about 525° C., about 550° C., about 575° C., or about 625° C. when introduced into the housing 1015. The heated exhaust gas in line 1011 can be at a pressure in a range from about 101 kPa-absolute to about 110 kPa-absolute when introduced into the housing 1015.

A pre-heated first aqueous fluid via line 1030 can be introduced into an inlet 1031 of the first coil 1019. As the pre-heated first aqueous fluid introduced via line 1030 flows through the first coil 1019, heat can be indirectly transferred from the heated exhaust gas introduced via line 1011 to the housing 1015 to produce a steam feed and a first cooled exhaust gas 1033. The steam feed can be removed from the first coil via an outlet 1032 of the first coil 1019 and into line 1035. In some embodiments, the pre-heated first aqueous fluid in line 1030 can be at a temperature in range from about 75° C., about 80° C., or about 85° C. to about 90° C., about 95° C., or about 99° C. when introduced into the inlet 1031 of the first coil 1019. In some embodiments, the steam feed in line 1035, upon exiting the outlet 1032 of the first coil 1019 can at a temperature in a range from about 400° C., about 410° C., about 420° C., or about 425° C. to about 435° C., about 445° C., about 450° C., or about 460° C. In some embodiments, the steam feed in line 1035, upon exiting the outlet 1032 of the first coil 1019 can be at a pressure in a range from about 4,000 kPa-gauge, about 4,250 kPa-gauge, or about 4,500 kPa-gauge to about 4,750 kPa-gauge, about 5,000 kPa-gauge, about 5,250 kPa-gauge, or about 5,500 kPa-gauge.

A cooled second aqueous fluid via line 1072 can be introduced into an inlet 1022 of the second coil 1021. As the cooled second aqueous fluid introduced via line 1072 flows through the second coil 1021, heat can be indirectly transferred from the first cooled exhaust gas 1033 to produce a heated second aqueous fluid and a second cooled exhaust gas 1034.

In some embodiments, the first cooled exhaust gas 1033 can be at a temperature in a range from about 250° C., about 255° C., about 275° C., or about 300° C. to about 330° C., about 345° C., about 350° C., or about 375° C. when initially contacted with the second coil 1021. In some embodiments, the cooled second aqueous fluid in line 1072 can be at a temperature in a range from about 50° C., about 55° C., about 60° C., about 65° C., or about 70° C. to about 80° C., about 85° C., about 90° C., about 95° C., or about 99° C. when introduced into the inlet 1022 of the second coil 1021. In some embodiments, the cooled second aqueous fluid in line 1072 can be at a pressure in a range from about 700 kPa-gauge, about 800 kPa-gauge, or about 900 kPa-gauge to about 1,000 kPa-gauge, about 1,100 kPa-gauge, about 1,200 kPa-gauge, or about 1,300 kPa-gauge when introduced into the inlet 1022 of the second coil 1021.

The heated second aqueous fluid can be removed from the second coil 1021 via an outlet 1023 of the second coil 1021 and into line 1074. In some embodiments, the heated second aqueous fluid can be at a temperature in a range from about 140° C., about 150° C., about 160° C., or about 170° C. to about 180° C., about 190° C., about 200° C., or about 210° C. upon exiting the outlet 1023 of the second coil 1021. In some embodiments, the heated second aqueous fluid in line 1074 can be at a pressure in a range from about 700 kPa-gauge, about 800 kPa-gauge, or about 900 kPa-gauge to about 1,000 kPa-gauge, about 1,100 kPa-gauge, about 1,200 kPa-gauge, or about 1,300 kPa-gauge upon exiting the outlet 1023 of the second coil 1021. In some embodiments, the second cooled exhaust gas 1034 can be at a temperature in a range from about 130° C., about 150° C., or about 170° C. to about 180° C., about 190° C., or about 200° C. upon exiting the outlet 1017 of the housing 1015.

At least a portion of the steam feed in line 1035 can be introduced into an inlet 1041 of an expander 1043 of the steam turbine 1040. The steam feed introduced via line 1035 into the expander 1043 can cause a turbine to spin thereby generating mechanical power and a cooled first aqueous fluid. In some embodiments, the mechanical power generated via the expander 1043 can be used to drive one or more electrical generators 1048 via shaft 1047. The electrical generator 1048 can include any device capable of converting mechanical energy into electrical energy. Illustrative electrical generators 1048 can include, but are not limited to, synchronous and induction type generators. In other embodiments, the mechanical power generated via the expander 1043 can be used to drive one or more mechanical units, e.g., a compressor, via shaft 1047. In still other embodiments, the mechanical power generated via the expander 1043 can be used to drive one or more electrical generators 1048 and one or more mechanical units, e.g., a compressor, via shaft 1047.

The cooled first aqueous fluid can be removed via an outlet 1045 of the expander 1043 and conveyed therefrom via line 1050. As shown, the cooled first aqueous fluid via line 1050 can be introduced into the primary condenser 1053. A heat transfer medium via line 1054 can also be introduced into the primary condenser 1053 and heat can be transferred from the cooled first aqueous fluid to the heat transfer medium to produce a further cooled first aqueous fluid and a heated heat transfer medium that can be removed from the primary condenser 1053 via lines 1056 and 1057, respectively.

The cooled first aqueous fluid via line 1056 and the heated second aqueous fluid via line 1074 can be introduced into a first inlet 1062 and a second inlet 1063, respectively, of the primary indirect heat exchanger 1060. Heat can be transferred from the heated second aqueous fluid to the cooled first aqueous fluid within the primary indirect heat exchanger 1060 to produce the preheated first aqueous fluid that can be removed through a first outlet 1064 of the primary indirect heat exchanger 1060 and into line 1030 and an intermediately cooled second aqueous fluid that can be removed through a second outlet 1065 of the primary indirect heat exchanger 1060 into line 1061.

In some embodiments, the heated second aqueous fluid can be at a temperature in a range from about 150° C. to about 210° C. when introduced via line 1074 into the primary indirect heat exchanger 1060. In some embodiments, the cooled first aqueous fluid can be at a temperature of about 70° C. or less, e.g., about 40° C. to about 60° C., when introduced via line 1056 into the primary indirect heat exchanger 1060. In some embodiments, the pre-heated first aqueous fluid can be at a temperature in a range from about 75° C. to about 99° C. upon exiting the primary indirect heat exchanger 1060 via line 1030. In some embodiments, the intermediately cooled second aqueous fluid can be at a temperature in a range from about 105° C. to about 135° C. upon exiting the primary indirect heat exchanger 1060 via line 1061.

As also shown in the FIGURE, in some embodiments, a first portion of the steam feed via line 1035 can be introduced into the inlet 1041 of the expander 1043 of the steam turbine 1040 and a second portion of the steam feed in line 1035 can be introduced via line 1090 into the auxiliary condenser 1091. A heat transfer medium via line 1092 can be introduced into the auxiliary condenser 1091 and heat can be transferred from the second portion of the steam feed to produce an intermediately cooled second portion of the steam feed via line 1093 and a heated heat transfer medium via line 1094. In such embodiment, a process controller 1036 and a process controller 1037 can communicate with one another to actuate valves 1038 and 1039, respectively, to adjust a flow rate of the steam feed introduced via line 1035 into the expander 1043 and a flow rate of the steam feed introduced via line 1090 into the auxiliary condenser 1091.

In some embodiments, the intermediately cooled second portion of the steam feed via line 1093 can be introduced into the sub-cooler 1095 and a heat transfer medium via line 1096 can also be introduced into the sub-cooler 1095. Heat can be transferred from the intermediately cooled second portion of the steam feed to the heat transfer medium to produce a cooled second portion of the steam feed via line 1097 and a heated heat transfer medium via line 1098. The sub-cooler 1095 can be used to ensure the intermediately cooled second portion of the steam feed in line 1093 can be in the liquid phase. The cooled second portion of the steam feed via line 1097 can be combined with the cooled first aqueous fluid in line 1056 and the combined mixture can be introduced via line 1056 into the primary indirect heat exchanger 1060. As such, in some embodiments line 1056 can serve as a conduit configured to receive and combine at least a portion of the cooled second portion of the first steam feed in line 1097 with at least a portion of the cooled first aqueous fluid in line 1056 recovered from the outlet 1045 of the steam turbine generator 1043. It should be understood that, depending, at least in part, on the given requirements of the system 1000, the sub-cooler 1095 can be omitted or bypassed at times. It should also be understood that, depending, at least in part, on the given requirements of the system 1000, the auxiliary condenser 1091 and the sub-cooler 1095 can be omitted or bypassed at times with all of the steam feed in line 1035 introduced into the inlet 1041 of the expander 1043.

In some embodiments, the intermediately cooled second aqueous fluid in line 1061 can be a first intermediately cooled second aqueous fluid. In such embodiment, as shown in the Figure, the first intermediately cooled second aqueous fluid via line 1061 can be introduced into one or more heat medium users or heat medium sinks 1066. Within the heat medium user or heat medium sink 1066, heat can be transferred from the first intermediately cooled second aqueous fluid to one or more heat mediums to produce a second intermediately cooled second aqueous fluid that can be recovered via line 1067. In some embodiments, the heat medium(s) in the heat medium user or heat medium sink 1066 can be a liquid hydrocarbon, a gaseous hydrocarbon, water, or any other heat medium. As such, in some embodiments, the heat medium user or heat medium sink 1066 can be an oil heater, a fuel gas heater, a water heater, or a combination thereof.

The second intermediately cooled second aqueous fluid via line 1067 can be introduced into the expansion vessel 1068. The expansion vessel 1068 can be used to maintain a desired pressure of the second aqueous fluid. The second intermediately cooled second aqueous fluid can be removed via line 1069 from the expansion vessel 1068. In some embodiments, the second intermediately cooled second aqueous fluid can be at a temperature in a range from about 50° C. to about 105° C. In some embodiments, the second intermediately cooled second aqueous fluid in line 1069 can be suitable for introduction into the second coil 1021. For example, when the second intermediately cooled second aqueous fluid has a temperature of about 90° C. or less, e.g., a temperature in a range from about 60° C. to about 90° C., the second intermediately cooled second aqueous fluid via line 1069 can be introduced into the second coil 1021. As shown, in some embodiments, the second intermediately cooled second aqueous fluid via line 1069 can be introduced into the trim cooler 1070 along with a heat transfer medium via line 1071. In such embodiment, heat can be transferred from the second intermediately cooled second aqueous fluid to the heat transfer medium within the trim cooler 1070 to produce the cooled second aqueous fluid in line 1072 and a heated heat transfer medium in line 1073. The amount of heat removed from the second intermediately cooled second aqueous fluid in line 1069 can be controlled by monitoring a temperature via a temperature transmitter, thermocouple (or other temperature sensor) 1078 of the heated second aqueous fluid in line 1074. More particularly, when the temperature transmitter, thermocouple 1078 detects a temperature of the heated second aqueous fluid exceeding or falling below a desired temperature, e.g., a temperature of about 200° C. to about 250° C., the temperature transmitter, thermocouple 1078 can further open or close valve 1079 to adjust the flow rate of the heat transfer medium introduced via line 1071 into the trim cooler 1070.

In some embodiments, a portion of the second intermediately cooled second aqueous fluid in line 1069 can be combined via line 1075 with the first intermediately cooled second aqueous fluid in line 1061 when the first intermediately cooled second aqueous fluid is at a temperature equal to or greater than a predetermined temperature. The temperature of the first intermediately cooled second aqueous fluid in line 1061 can be measured via a temperature transmitter, thermocouple (or other temperature sensor) 1076 and when the temperature transmitter, thermocouple 1076 measures a temperature at or above the predetermined temperature, the thermocouple can initiate opening a valve 1077 that can allow a portion of the second intermediately cooled second aqueous fluid in line 1069 to mix with the first intermediately cooled second aqueous fluid in line 1061 to produce a combined mixture or feed in line 1061 to have a temperature less than the predetermined temperature. In some embodiments, the predetermined temperature can be greater than or equal to 120° C., e.g., a temperature in a range from about 120° C. to about 135° C.

In some embodiments, a temperature of the steam feed in line 1035, upon exiting the first coil 1019, can be monitored via a temperature transmitter, thermocouple (or other temperature sensor) 1080. When the temperature of the steam feed in line 1035 exceeds or falls below a desired temperature, e.g., a temperature in a range from about 410° C. to about 455° C., the temperature transmitter, thermocouple 1080 can open or close a valve 1081 that can increase or decrease a flow rate of the pre-heated first aqueous fluid in line 1030 that can be combined with the steam feed (or completely stopped) to adjust the temperature of the steam feed in line 1035.

In some embodiments, an amount of the pre-heated first aqueous fluid introduced into the first coil 1019 can be adjusted via a process flow controller 1082. More particularly, the process flow controller 1082 can adjust the flowrate of the pre-heated first aqueous fluid introduced via line 1030 into the inlet 1031 of the first coil 1019 by actuating a valve 1083.

It should be understood that any suitable system that includes a combustor capable of producing a satisfactory heated exhaust gas of adequate mass flow that can be introduced via line 1011 into the housing 1015 can be used in lieu of or in addition to the gas turbine 1001 shown in the Figure. Illustrative additional systems that includes a combustor can include, but are not limited to, an exhaust gas produced by combusting a fuel in an incinerator, an exhaust gas produced by combusting a fuel in an external supplemental firing combustor burner, or a combination thereof.

It should be understood that one or more additional process units can be disposed between the primary condenser 1053 and, if present, the auxiliary condenser 1091 and the sub-cooler 1095 that can be configured to further process the cooled first aqueous fluid in line 1050 or the cooled first portion of the steam feed in line 1050 and the cooled second portion of the steam feed in line(s) 1093, 1097 before introduction of the cooled first aqueous fluid into the first inlet 1062 of the indirect heat exchanger 1060. In some embodiments, such additional process units can be or can include, but are not limited to, one or more vacuum units, one or more vacuum deaerators, a polishing unit, a filter unit, e.g., an activated carbon filter, one or more demineralization units, one or more mixed bed polishers, one or more electro-deionization (EDI) modules, one or more reverse osmosis units, or any combination thereof. It should also be understood that a portion of the cooled first aqueous fluid can be recycled, e.g., to the inlet of the primary condenser 1053 and/or to a flash vessel from which the aqueous fluid can be recycled to mix with the cooled first aqueous fluid in line 1056 upon exiting the primary condenser 1053, and so on. The additional process units and configurations or arrangements thereof that can be used to further treat or process the first cooled aqueous fluid recovered from the primary condenser and, if present, the auxiliary condenser are well-known to persons having ordinary skill in the art.

It should also be understood that one or more pumps or other fluid circulating devices can be used to move the cooled first aqueous fluid in line 1056 or the cooled first portion of the steam feed and the cooled second portion of the steam feed in lines 1056, 1097. It should also be understood that one or more pumps or other fluid circulating devices can be used to move the second aqueous fluid through lines 1061, 1067, 1069, 1072, 1074, and 1075. For example, in some embodiments, one or more pumps can be located in line 1069 that can be used to circulate the second aqueous medium.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim can be not defined above, it should be given the broadest definition persons in the pertinent art have given that term as reflected in at least one printed publication or issued patent. Furthermore, all patents, test procedures, and other documents cited in this application are fully incorporated by reference to the extent such disclosure can be not inconsistent with this application and for all jurisdictions in which such incorporation can be permitted.

While certain preferred embodiments of the present invention have been illustrated and described in detail above, it can be apparent that modifications and adaptations thereof will occur to those having ordinary skill in the art. It should be, therefore, expressly understood that such modifications and adaptations may be devised without departing from the basic scope thereof, and the scope thereof can be determined by the claims that follow.

What is claimed is:

1. A system, comprising:
a combustor configured to combust a fuel to produce a heated exhaust gas;
a housing having an inlet configured to receive the heated exhaust gas and an outlet configured to remove a cooled exhaust gas therefrom;
a first coil disposed within the housing having an inlet configured to receive a pre-heated first aqueous fluid and an outlet configured to remove a steam feed therefrom;
a steam turbine generator having an inlet configured to receive at least a portion of the steam feed from the outlet of the first coil to produce power and an outlet configured to remove a cooled first aqueous fluid therefrom;
a second coil disposed within the housing having an inlet configured to receive a cooled second aqueous fluid and an outlet configured to remove a heated second aqueous fluid therefrom; and
a primary indirect heat exchanger having a first inlet, a second inlet, a first outlet, and a second outlet, wherein:
the first inlet of the primary indirect heat exchanger is configured to receive the cooled first aqueous fluid from the steam turbine generator,
the second inlet of the indirect heat exchanger is configured to receive the heated second aqueous fluid from the second coil,
the primary indirect heat exchanger is configured to indirectly transfer heat from the heated second aqueous fluid to the cooled first aqueous fluid to produce the pre-heated first aqueous fluid and an intermediately cooled second aqueous fluid,
the first outlet of the primary indirect heat exchanger is in fluid communication with the inlet of the first coil, and
the second outlet of the primary indirect heat exchanger is in fluid communication with the inlet of the second coil.

2. The system of claim 1, wherein the first coil is disposed within the housing between the inlet of the housing and the second coil, and wherein the second coil is disposed within the housing between the first coil and the outlet of the housing.

3. The system of claim 1, further comprising a primary condenser having an inlet configured to receive the cooled first aqueous fluid from the outlet of the steam turbine generator and an outlet in fluid communication with the first inlet of the indirect heat exchanger.

4. The system of claim 3, wherein the inlet of the steam turbine generator is configured to receive a first portion of the first steam feed such that the cooled first aqueous fluid recovered from the outlet of the steam turbine generator comprises a first portion of the first steam feed, the system further comprising an auxiliary condenser having an inlet configured to receive a second portion of the first steam feed and an outlet configured to remove a cooled second portion of the first steam feed; and a conduit configured to receive and combine at least a portion of the cooled second portion of the first steam feed with at least a portion of the cooled first aqueous fluid recovered from the outlet of the steam turbine generator.

5. The system of claim 1, further comprising one or more secondary indirect heat exchangers disposed between the second outlet of the primary indirect heat exchanger and the inlet of the second coil, wherein the one or more secondary indirect heat exchangers is configured to indirectly exchange heat from the intermediately cooled second aqueous fluid to one or more heat mediums to produce the cooled second aqueous fluid.

6. The system of claim 5, wherein the one or more secondary indirect heat exchangers is configured to indirectly exchange heat from the intermediately cooled second aqueous fluid to a liquid hydrocarbon, a gaseous hydrocarbon, or a combination thereof.

7. The system of claim 5, wherein the one or more secondary indirect heat exchangers comprises at least a first secondary indirect heat exchanger configured to indirectly transfer heat from the intermediately cooled second aqueous fluid to a first heat exchange medium to produce a second intermediately cooled second aqueous fluid and at least a second secondary indirect heat exchanger configured to indirectly transfer heat from the second intermediately cooled second aqueous fluid to a second heat exchange medium to produce the cooled second aqueous fluid.

8. The system of claim 7, further comprising at least one conduit configured to be in fluid communication with the outlet of the first secondary indirect heat exchanger and the second outlet of the primary indirect heat exchanger via actuation of a valve such that a portion of the second intermediately cooled second aqueous fluid is configured to be combined with the intermediately cooled second aqueous fluid.

9. The system of claim 1, wherein the combustor comprises a gas turbine.

10. The system of claim 1, wherein the system is disposed on a vessel that is floating on a surface of a body of water.

11. The system of claim 10, wherein the fuel the combustor is configured to combust is configured to be obtained via heating a crude oil located within a storage tank disposed on the vessel.

12. A process, comprising:
combusting a fuel to produce a heated exhaust gas;
indirectly transferring heat from the heated exhaust gas to a pre-heated first aqueous fluid to produce a steam feed and a first cooled exhaust gas;
introducing at least a portion of the steam feed into a steam turbine generator to produce power and a cooled first aqueous fluid;
indirectly transferring heat from the first cooled exhaust gas to a cooled second aqueous fluid to produce a heated second aqueous fluid and a second cooled exhaust gas; and
indirectly transferring heat from the heated second aqueous fluid to the cooled first aqueous fluid to produce the pre-heated first aqueous fluid and an intermediately cooled second aqueous fluid.

13. The process of claim 12, wherein at least a portion of the cooled first aqueous fluid passes through a primary condenser prior to indirectly transfer heat from the heated second aqueous fluid to the cooled first aqueous fluid.

14. The process of claim 12, wherein a first portion of the first steam feed is introduced into the steam turbine generator and a second portion of the first steam feed is introduced into an auxiliary condenser.

15. The process of claim 12, wherein the cooled second aqueous fluid, the heated second aqueous fluid, and the intermediately cooled second aqueous fluid circulate within a closed loop.

16. The process of claim 12, further comprising indirectly transferring heat from the intermediately cooled second aqueous fluid to one or more heat mediums to produce the cooled second aqueous fluid.

17. The process of claim 12, wherein the intermediately cooled second aqueous fluid is a first intermediately cooled second aqueous fluid, the process further comprising:
indirectly transferring heat from the first intermediately cooled second aqueous fluid to one or more first heat mediums to produce a second intermediately cooled second aqueous fluid;
combining a first portion of the second intermediately cooled second aqueous fluid with the first intermediately cooled second aqueous fluid; and
indirectly transferring heat from a second portion of the second intermediately cooled second aqueous fluid to one or more second heat transfer mediums to produce the cooled second aqueous fluid.

18. The process of claim 17, wherein:
the first portion of the second intermediately cooled second aqueous fluid is combined with the first intermediately cooled second aqueous fluid when the first intermediately cooled second aqueous fluid is at a temperature equal to or greater than a predetermined temperature to produce a combined feed having a temperature less than the predetermined temperature,
the second intermediately cooled second aqueous fluid is at a temperature in a range from 50° C. to about 105° C., and
the predetermined temperature is in a range of about 120° C. to about 135° C.

19. The process of claim 12, wherein at least one of the following is met:
the heated exhaust gas is at a temperature in a range from about 425° C. to about 575° C.,
the pre-heated first aqueous fluid is at a temperature in a range from about 75° C. to about 99° C.,
the steam feed is at a temperature in a range from about 400° C. to about 450° C. and a pressure in a range from about 4 MPa-gauge to about 5.5 MPa-gauge
the first cooled exhaust gas is at a temperature in a range from about 255° C. to about 345° C.,
the cooled second aqueous fluid is at a temperature in a range from about 55° C. to about 95° C.,
the heated second aqueous fluid is at a temperature in a range from about 150° C. to about 210° C.,
the second cooled exhaust gas is at a temperature in a range from about 130° C. to about 200° C.,
the cooled first aqueous fluid is at a temperature of about 70° C. or less,
the intermediately cooled second aqueous fluid is at a temperature in a range from about 105° C. to about 135° C.,
the cooled first aqueous fluid is at a pressure that is greater than the heated second aqueous fluid,
the cooled first aqueous fluid is at a pressure in a range from about 4,000 kPa-gauge to about 6,000 kPa-gauge when the heat is indirectly transferred from the heated second aqueous fluid to the cooled first aqueous fluid, and
the heated second aqueous fluid is at a pressure in a range from about 700 kPa-gauge to about 1,300 kPa-gauge when the heat is indirectly transferred from the heated second aqueous fluid to the cooled first aqueous fluid.

20. A process, comprising:
combusting a fuel within a combustor to produce a heated exhaust gas;
introducing at least a portion of the heated exhaust gas into an inlet of a housing that includes a first coil and a second coil disposed therein;
introducing a pre-heated first aqueous fluid into an inlet of the first coil;
indirectly transferring heat from the heated exhaust gas to the pre-heated first aqueous fluid flowing through the first coil to produce a steam feed and a first cooled exhaust gas;
removing the steam feed from the first coil via an outlet of the first coil;
introducing at least a portion of the steam feed into an inlet of a steam turbine generator to produce power and a cooled first aqueous fluid;
removing the cooled first aqueous fluid from the steam turbine generator via an outlet of the steam turbine generator;
introducing a cooled second aqueous fluid into an inlet of the second coil;
indirectly transferring heat from the first cooled exhaust gas to the cooled second aqueous fluid flowing through the second coil to produce a heated second aqueous fluid and a second cooled exhaust gas;
removing the heated second aqueous fluid from the second coil via an outlet of the second coil;
removing the second cooled exhaust gas from the housing through an outlet of the housing;
introducing the cooled first aqueous fluid into a first inlet of an indirect heat exchanger;
introducing the heated second aqueous fluid into a second inlet of the indirect heat exchanger;
indirectly exchanging heat from the heated second aqueous fluid to the cooled first aqueous fluid to produce the pre-heated first aqueous fluid and an intermediately cooled second aqueous fluid;
removing the pre-heated first aqueous fluid from the indirect heat exchanger via a first outlet of the indirect heat exchanger, wherein the first outlet of the indirect heat exchanger is in fluid communication with the inlet of the steam turbine generator; and
removing the intermediately cooled second aqueous fluid from the indirect heat exchanger via a second outlet of the indirect heat exchanger, wherein the inlet of the second coil is in fluid communication with the second outlet of the indirect heat exchanger.
